(19) United States
(12) Patent Application Publication
(10) Pub. No.: US 2007/0114903 A1
(43) Pub. Date: May 24, 2007

(54) Multi-channel plasma accelerator

(75) Inventors: Yuri Tolmachev, Suwon-si (KR); Vasily Pashkovski, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/452,930

(22) Filed: Jun. 15, 2006

(30) Foreign Application Priority Data
Jun. 17, 2005 (KR) 2005-0052615

(51) Int. Cl. H01J 17/26; H01J 61/28

(52) U.S. Cl. 313/231.31

(57) ABSTRACT

A multi-channel plasma accelerator is provided. The multi-channel plasma accelerator includes a central cylinder formed along a surface comprising a blocked upper surface so as to form a first channel inside the cylinder; and first and second outer cylinders formed along the surface, each having an identical coaxial shaft to the central cylinder, and a diameter of the first outer cylinder being larger than a diameter of the central cylinder and a diameter of the second outer cylinder being larger than the diameter of the first outer cylinder so as to form a second channel as a space between the first and second outer cylinders.

### CROSS-REFERENCE TO RELATED APPLICATION

This application claims priority from Korean Patent Application No. 10-2005-0052615 filed Jun. 17, 2005, in the Korean Intellectual Property Office, the entire disclosure of which is incorporated herein by reference.

### BACKGROUND OF THE INVENTION

1. Field of the Invention

The present invention relates to a plasma accelerator, and more particularly, to a multi-channel plasma accelerator including a plurality of channels.

2. Description of the Related Art

Plasma accelerators accelerate flows of plasmas generated or existing in predetermined spaces using electric and magnetic energies.

Plasma accelerators have been developed with research on ion engines and nuclear fusion of long distance space travel rockets and are now used for etching wafers in semiconductor manufacturing processes.

Plasma is a gas state divided into negatively charged electrons and positively charged ions at a high temperature. In other words, the plasma is a neutral gas due to a considerably high charge division and the same number of negative and positive charges. The plasma is strictly called a fourth material state flowing solid, liquid, and gas (three kinds of states of a material). If temperature is gradually increased, almost all objects are changed from solid to liquid states into gas states. Gas is divided into electrons and atomic nuclei at tens of thousands of ° C. to be a plasma state.

FIG. 1 is a cut perspective view of a conventional plasma accelerator. Referring to FIG. 1, the conventional plasma accelerator includes inner and outer circular loop coils 10 and 20, an outer cylinder 30, an inner cylinder 60, a channel 40 formed between the outer and inner cylinders 30 and 60, and a discharge coil 50 installed at a bottom of the channel 40.

The inner and outer circular loop coils 10 and 20 are coaxially disposed and apply a current in a direction along which the inner and outer circular loop coils 10 and 20 enclose the channel 40. A current is applied to the inner and outer circular loop coils 10 and 20 clockwise or counterclockwise to generate a magnetic field crossing an inside of the channel 40. The inner and outer circular loop coils 10 and 20 reduce a current flowing in coils wound in an axis direction to reduce the magnetic field induced inside the channel 40 in the axis direction. The magnetic field is perpendicular to the axis direction to cross the channel 40 so as to gradually decrease in the axis direction. The magnetic field formed inside the channel 40 induces a secondary current according to Maxwell's equations. Plasma formed inside the channel 40 by the discharge coil 50 is accelerated toward an exit 70 in the axis direction due to the magnetic field crossing the channel 40 and the secondary current.

The conventional plasma accelerator uses a B-field modulation method in which a great current is applied to coils wound toward an entrance 80 and a small current is applied to coils wound toward the exit 70 to produce a difference in a magnetic pressure so as to accelerate plasma. The conventional plasma accelerator using the B-field modulation method causes radiative non-uniformity of plasma and ions.

### SUMMARY OF THE INVENTION

Accordingly, the present general inventive concept has been made to address the above-mentioned and other problems, and an aspect of the present general inventive concept is to provide a multi-channel plasma accelerator including a plurality of channels so as to produce a uniform density of plasma.

Another aspect of the present general inventive concept is to provide an etching apparatus for etching a wafer used for manufacturing a semiconductor chip using the multi-channel plasma accelerator.

According to an aspect of the present invention, there is provided a multi-channel plasma accelerator including a central cylinder formed along a surface comprising a blocked upper surface so as to form a first channel inside the cylinder; and first and second outer cylinders formed along the surface, each having an identical coaxial shaft to the central cylinder, and a diameter of the first outer cylinder being larger than a diameter of the central cylinder and a diameter of the second outer cylinder being larger than the diameter of the first outer cylinder so as to form a second channel as a space between the first and second outer cylinders.

The multi-channel plasma accelerator may further include a first connector connecting the central cylinder to the first outer cylinder; and a second connector connecting the first outer cylinder to the second outer cylinder.

The multi-channel plasma accelerator may further include a plurality of upper coils independently supplied with radio frequency power to induce an electromagnetic field so as to form a plasma; and a plurality of side coils offsetting a portion of the electromagnetic field in an axis direction so as to accelerate the plasma in the axis direction.

The plurality of upper coils may include first and second upper coils formed along upper surfaces of the central cylinder and of the second connector, respectively, the first and second upper coils generating a ponderomotive force toward exits of the first and second channels to accelerate the plasma toward the exits.

The plurality of side coils may include first and second side coils formed along an inner side of the first outer cylinder and an outer side of the second outer cylinder, respectively, the first and second side coils operating to move waves of the electromagnetic field formed inside the first and second channels, and to accelerate the plasma inside the first and second channels.

At least one of heights and widths of the first and second channels and heights of exits of the first and second channels may be changed to uniformly adjust a density of the plasma formed inside the first and second channels.

The central cylinder and the first and second outer cylinders may be dielectrics.

According to another aspect of the present invention, there is provided a multi-channel plasma accelerator including a central cylinder formed along a surface of a cylinder comprising a blocked upper surface so as to form a first channel inside the cylinder; and first through fourth outer cylinders formed along the surface of the cylinder, each having an identical coaxial shaft to the central cylinder, and each having a diameter d1, d2, d3, and d4, respectively, wherein d1 is greater than a diameter of the central cylinder, and d2>d1, d3>d2, and d4>d3, and wherein a second channel is formed between the first and second outer cylinders, and a third channel is formed between the third and fourth outer cylinders.

The multi-channel plasma accelerator may further include a first connector connecting the central cylinder to the first outer cylinder; a second connector connecting the first outer cylinder to the second outer cylinder; a third connector connecting the second outer cylinder to the third outer cylinder; and a fourth connector connecting the third outer cylinder to the fourth outer cylinder.

The multi-channel plasma accelerator may further include a plurality of upper coils independently supplied with radio frequency power to induce an electromagnetic field so as to form a plasma; and a plurality of side coils offsetting a portion of the electromagnetic field in an axis direction so as to accelerate the plasma in the axis direction.

The plurality of upper coils may include first, second, and third upper coils formed along upper surfaces of the central cylinder, the second connector, and the fourth connector, respectively, and generating a ponderomotive force toward exits of the first, second, and third channels so as to accelerate the plasma toward the exits.

The plurality of side coils may include first, second, and third side coils formed along an inner side of the first outer cylinder, an inner side of the third outer cylinder, and an outer side of the fourth outer cylinder, respectively, the plurality of side coils operating to move waves of the electromagnetic field formed inside the first, second, and third channels, and to accelerate the plasma inside the first, second, and third channels.

At least one of height and widths of the first, second, and third channels and heights of exits of the first, second, and third channels may be changed so as to uniformly adjust a density of the plasma formed inside the first, second, and third channels.

The central cylinder and the first, second, and third outer cylinders may be dielectric.

According to still another aspect of the present invention, there is provided an etching apparatus etching a wafer used for manufacturing a semiconductor chip using the multi-channel plasma accelerator of the present invention.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a cut perspective view of a conventional plasma accelerator;

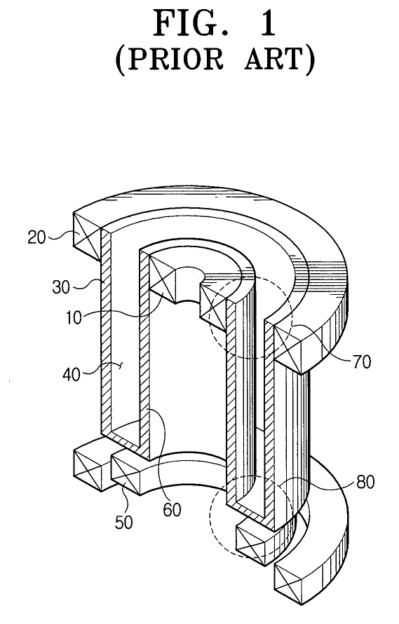

FIG. 2 is a cut perspective view of a multi-channel plasma accelerator including two channels according to an exemplary embodiment of the present invention;

FIG. 3 is a view illustrating a wave of a magnetic pressure moving inside a plurality of channels at a period of time t (=0.025 μsec);

FIG. 4 is a cut perspective view of a multi-channel plasma accelerator including three channels according to another exemplary embodiment of the present invention;

FIG. 5 is a cross-sectional view illustrating a right side of the multi-channel plasma accelerator including three channels of FIG. 4 based on a central axis of a central cylinder according to an exemplary embodiment of the present invention; and

FIG. 6 is a cross-sectional view illustrating a right side of the multi-channel plasma accelerator including three channels based on a central axis of a central cylinder according to another exemplary embodiment of the present invention.

### DETAILED DESCRIPTION OF EXEMPLARY EMBODIMENTS OF THE PRESENT INVENTION

Certain exemplary embodiments of the present invention will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

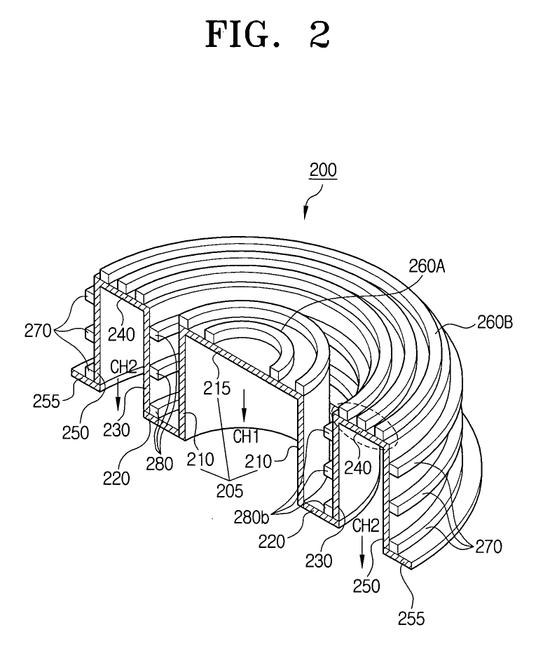

FIG. 2 is a cut perspective view of a multi-channel plasma accelerator including two channels according to an exemplary embodiment of the present invention. Referring FIG. 2, a multi-channel plasma accelerator 200 including two channels according to an exemplary embodiment of the present invention includes a central cylinder 205, first and second outer cylinders 230 and 250, first, second, and third connectors 220, 240, and 255, and a plurality of coils 260A, 260B, 270, and 280.

The plurality of coils 260A, 260B, 270, and 280 are greatly classified into upper coils 260A and 260B and side coils 270 and 280. The upper coils 260A and 260B are re-classified into first and second upper coils 260A and 260B, and the side coils 270 and 280 are re-classified into first and second side coils 280 and 270.

The central cylinder 205 includes a side part 210 and an upper part 215 forming a first channel CH1 having a circular cross-section. The first coil 260A is wound along an upper surface of the upper part 215 so that a diameter of the first coil 260A is reduced.

The central cylinder 205 is connected to the first outer cylinder 230 via the first connector 220, and the first outer cylinder 230 is connected to the second outer cylinder 250 via the second connector 240 so as to form a second channel CH2 having a ring-shaped cross-section. The first and second channels CH1 and CH2 are formed toward an axis direction in a space in which plasma is generated and moved and include channel upper portions as upper portions of the first and second channels CH1 and CH2 and exits as lower portions of the first and second channels CH1 and CH2.

The first side coil 280 spirally wound along an inner side of the first outer cylinder 220 and the second side coil 270 spirally wound along an outer side of the second outer cylinder 250 offset a magnetic field of magnetic fields in the axis direction so as to accelerate plasma toward the axis direction. Also, the second upper coil 260B is wound along an upper surface of the second connector 240 so that a diameter of the second upper coil 260B is reduced.

The plurality of coils 260A, 260B, 270, and 280 apply a radio frequency (RF) power to the multi-channel plasma accelerator 200 to generate the plasma and form an inclination of a magnetic pressure inside the first and second channels CH1 and CH2 so as to accelerate the plasma from the channel upper portions toward the exits (in a direction indicated by an arrow shown in FIG. 2)

In more detail, the first and second upper coils 260A and 260B generate a ponderomotive force toward the exits so as to accelerate ions in an initial stage. The first and second upper coils 260A and 260B operate independently.

The first and second side coils 280 and 270 move waves of an electromagnetic field and further accelerate the ions inside the first and second channels CH1 and CH2 so as to synchronize the accelerations of the ions. Also, one of the first and second side coils 280 and 270 is commonly used by the first and second channels CH1 and CH2.

The first and second side coils 280 and 270 are wound one time as shown in FIG. 2 but may be wound several times. The numbers of turns of the first and second side coils 280 and 270 may vary. The first and second side coils 280 and 270 may be independently fed by a separate RF generator (not shown). The separate RF generator synchronizes currents flowing in the first and second side coils 280 and 270 so that a phase shift is controlled between the currents.

The RF power applied to the first and second channels CH1 and CH2 is relatively adjusted to uniformly adjust fluxes of the plasma and the ions. The currents flowing in the first ands second side coils 280 and 270 may be adjusted, or widths, depths, and diameters of the first and second channels CH1 and CH2 may be changed to uniformly adjust densities of the fluxes of the plasma and the ions.

The multi-channel plasma accelerator 200 shown in FIG. 2 includes two channels, but the multi-channel plasma accelerator 200 is not limited to only two channels. Moreover, the multi-channel plasma accelerator 200 may additionally include ring-shaped channels having large diameters so as to treat a larger substrate.

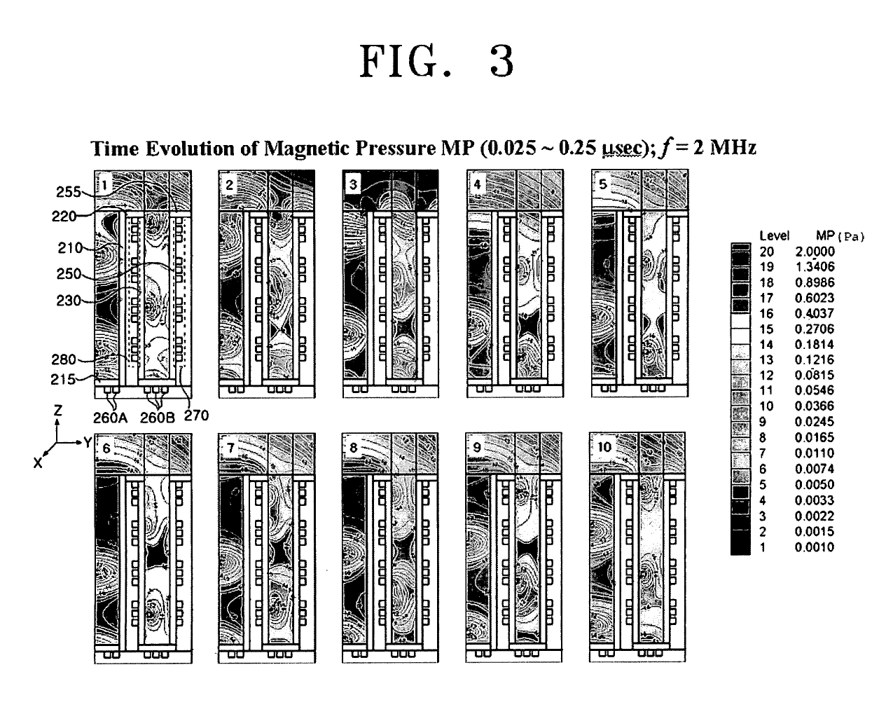

FIG. 3 is a view illustrating waves of a magnetic pressure moving inside a plurality of channels at every predetermined period of time t (=0.025 μsec). Referring to FIG. 3, a magnetic pressure inside the first and second channels CH1 and CH2 is expressed as in Equation 1:

$$MP = \frac{{B}^{2}}{2 {μ}_{0}} \qquad ( 1 )$$

wherein MP denotes the magnetic pressure, B denotes an intensity of a magnetic field, and μ₀ denotes a dielectric constant of a free space. The term “magnetic pressure” is used to compute an acceleration of plasma in electromagnetic fluid mechanics.

$$P + \frac{{B}^{2}}{2 {μ}_{0}} = const \qquad ( 2 )$$

wherein P denotes a pressure produced by plasma particles,

$$\frac{{B}^{2}}{2 {μ}_{0}}$$

denotes the magnetic pressure, and const denotes a constant. Equation 2 2,means that a sum of the pressure produced by the plasma particles and the magnetic pressure must be uniform. Thus, an inclination of the magnetic pressure generates a force applied to the plasma, and thus the plasma is accelerated along a direction toward which the magnetic pressure moves. The moving waves of the magnetic pressure are driven by the first and second side coils 280 and 270. The first and second side coils 280 and 270 are independently fed by a sine wave RF current having a phase shift of 90° between neighboring coils.

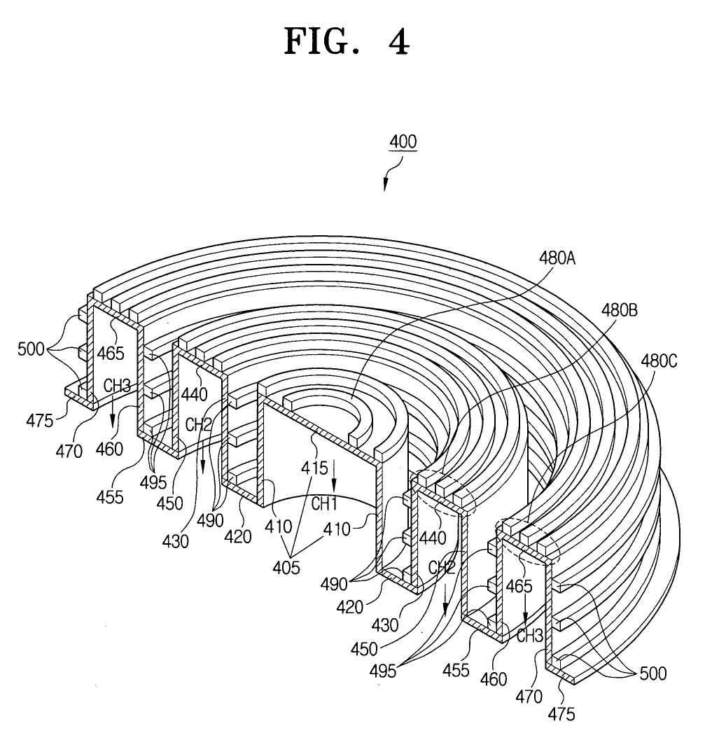

FIG. 4 is a cut perspective view of a multi-channel plasma accelerator including three channels according to another exemplary embodiment of the present invention.

Referring to FIG. 4, a multi-channel plasma accelerator 400 including three channels according to an exemplary embodiment of the present invention includes a central cylinder 405; first, second, third, and fourth outer cylinders 430, 450, 460, and 470; first, second, third, fourth, and fifth connectors 420, 440, 455, 465, and 475; and a plurality of coils 480A, 480B, 480C, 490, 495, and 500. The plurality of coils 480A, 480B, 480C, 490, 495, and 500 are classified into upper coils 480A, 480B, and 480C and side coils 490, 495, and 500. The upper coils 480A, 480B, and 480C are re-classified into first, second, and third upper coils 480A, 480B, and 480C, and the side coils 490, 495, and 500 are re-classified into first, second, and third side coils 490, 495, and 500.

The central cylinder 405 includes a side part 410 and an upper part 415 forming a first channel CH1 having a circular cross-section. The first upper coil 480A is wound along an upper surface of the upper part 415 so that a diameter of the first upper coil 480A is reduced.

The central cylinder 405 is connected to the first outer cylinder 430 via the first connector 420, and the first outer cylinder 430 is connected to the second outer cylinder 450 via the second connector 440, so as to form a second channel CH2 having a ring-shaped cross-section. The second outer cylinder 450 is connected to the third outer cylinder 460 via the third connector 455, and the third outer cylinder 460 is connected to the fourth outer cylinder 470 via the fourth connector 465, so as to form a third channel CH3 having a ring-shaped cross-section.

The first side coil 490 spirally wound along an inner side of the first outer cylinder 430, the second side coil 495 spirally wound along an inner side of the third outer cylinder 460, and the third side coil 500 spirally wound along an outer side of the fourth outer cylinder 470 offset a portion of a magnetic field in an axis direction so as to accelerate plasma toward the axis direction.

The second upper coil 480B is wound along an upper surface of the second connector 440 so that a diameter of the second upper coil 480B is reduced, and the third upper coil 480C is wound along an upper surface of the fourth connector 465 so that a diameter of the third upper coil 480C is reduced.

The plurality of coils 480A, 480B, 480C, 490, 495, and 500 apply an RF power to the multi-channel plasma accelerator 400 to generate plasma and form an inclination of a magnetic pressure inside the first, second, and third channels CH1, CH2, and CH3 so as to accelerate the plasma from upper portions of the first, second, and third channels CH1, CH2, and CH3 toward exits of the first, second, and third channels CH1, CH2, and CH3 (in a direction indicated by an arrow shown in FIG. 4)

In more detail, the first, second, and third upper coils 480A, 480B, and 480C generate a ponderomotive force toward the exits so as to accelerate ions in an initial stage. The first, second, and third upper coils 480A, 480B, and 480C operate independently.

The first, second, and third side coils 490, 495, and 500 move waves of an electromagnetic field, further accelerate ions inside the first, second, and third channels CH1, CH2, and CH3, and synchronize the acceleration of the ions. The first, second, and third side coils 490, 495, and 500 are each wound one time as shown in FIG. 4 but may be wound several times. The numbers of turns of the first, second, and third side coils 490, 495, and 500 may vary. The first, second, and third side coils 490, 495, and 500 may be independently fed by an additional RF generator (not shown). The additional RF generator synchronizes the first, second, and third side coils 490, 495, and 500 so as to control a phase shift among currents flowing in the first, second, and third side coils 490, 405, and 500. An RF power applied to the first, second, and third channels CH1, CH2, and CH3 may be relatively adjusted to uniformly adjust fluxes of plasma and the ions. The currents flowing in the first, second, and third side coils 490, 495, and 500 may be adjusted, or widths, depths, and diameters of the first, second, and third channels CH1, CH2, and CH3 may be changed to uniformly adjust the fluxes of the plasma and the ions.

The multi-channel plasma accelerator 400 shown in FIG. 4 has three channels and thus can treat a greater substrate than the multi-channel plasma accelerator 200 having the two channels shown in FIG. 2. The multi-channel plasma accelerators 200 and 400 shown in FIGS. 2 and 4 may be used in an etching apparatus to be used for etching a wafer for manufacturing a semiconductor chip.

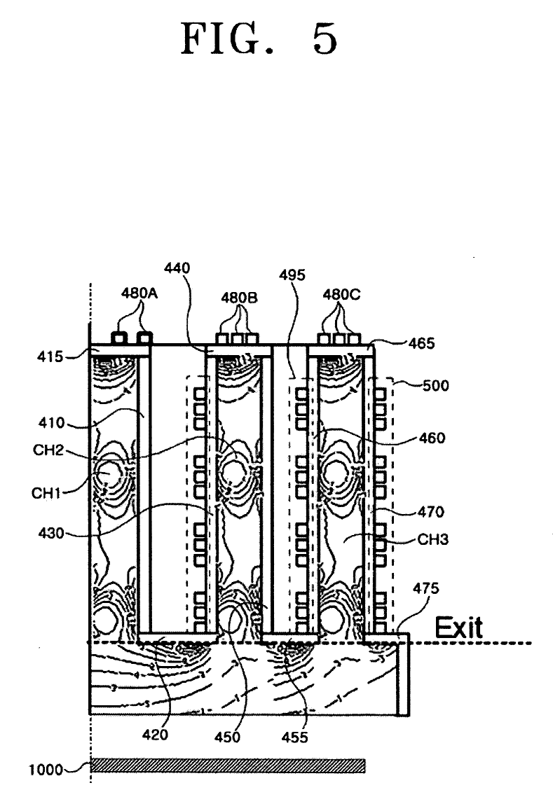

FIG. 5 is a cross-sectional view illustrating a right side of the multi-channel plasma accelerator 400 including three channels shown in FIG. 4 based on a central axis of a central cylinder to show a distribution of a magnetic pressure inside the channels. A left boundary line of FIG. 5 denotes a central axis of the central cylinder 405. Referring to FIG. 5, heights of the first, second, and third channels CH1, CH2, and CH3 are the same, and heights of exits of the first, second, and third channels CH1, CH2, and CH3 are the same. Distances from the exits of the first, second, and third channels CH1, CH2, and CH3 to a wafer 1000 may be changed to uniformly control fluxes of plasma and ions. This is because the ions flow out through the exits of the first, second, and third channels CH1, CH2, and CH3 and then are radiated to the wafer 1000.

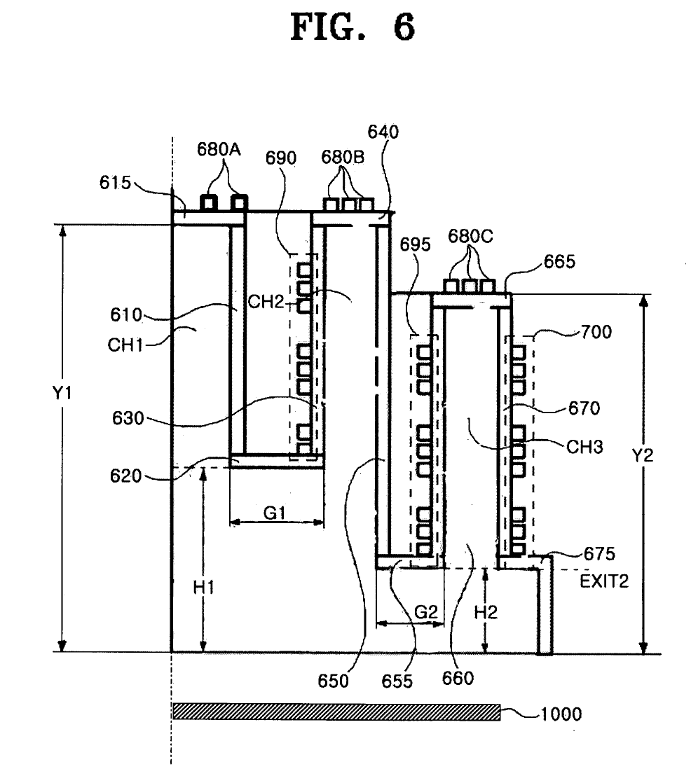

FIG. 6 is a view illustrating a multi-channel plasma accelerator including three channels according to another exemplary embodiment of the present invention. Referring to FIG. 6, heights Y1 of first and second channels CH1 and CH2 are different from a height Y2 of a third channel CH3. Also, a height H1 of an exit 1 of the first and second channels CH1 and CH2 is different from a height H2 of an exit 2 of the third channel CH3, and a gap G1 between the first and second channels CH1 and CH2 is different from a gap G2 between the second and third channels CH2 and CH3. As described above, a gap between channels or diameters of channels, heights of exits of the channels, heights of the channels, and the like can be adjusted so that a density of a plasma and a density of an ion current are uniform on a lower surface of a plasma accelerator.

If a ratio v/s of a surface area s of a channel to a volume v of the channel is large, a density of charge particles may be higher. Diameters of the cylinders forming the channels can be changed to control widths of the channels and a gap between the channels. Thus, a ratio of a surface area of each of the channels to a volume of each of the channels and a density of a plasma can be controlled.

As described above, a multi-channel plasma accelerator according to exemplary embodiments of the present invention can include a plurality of channels and uniform densities of plasma and fluxes of ions inside the channels. Thus, a substrate having a large area can be treated with a uniform etching ratio.

The foregoing embodiments and aspects are merely exemplary and are not to be construed as limiting the present invention. The present teaching can be readily applied to other types of apparatuses. Also, the description of exemplary embodiments of the present invention is intended to be illustrative, and not to limit the scope of the claims, and many alternatives, modifications, and variations will be apparent to those skilled in the art.

What is claimed is:

1. A multi-channel plasma accelerator comprising:
a central cylinder formed along a surface comprising a blocked upper surface so as to form a first channel inside the cylinder; and
first and second outer cylinders formed along the surface, each having an identical coaxial shaft to the central cylinder, and a diameter of the first outer cylinder being larger than a diameter of the central cylinder and a diameter of the second outer cylinder being larger than the diameter of the first outer cylinder so as to form a second channel as a space between the first and second outer cylinders.

2. The multi-channel plasma accelerator of claim 1, further comprising:
a first connector connecting the central cylinder to the first outer cylinder; and
a second connector connecting the first outer cylinder to the second outer cylinder.

3. The multi-channel plasma accelerator of claim 1, further comprising:
a plurality of upper coils independently supplied with radio frequency power to induce an electromagnetic field so as to form a plasma; and
a plurality of side coils offsetting a portion of the electromagnetic field in an axis direction so as to accelerate the plasma in the axis direction.

4. The multi-channel plasma accelerator of claim 3, wherein the plurality of upper coils comprises first and second upper coils formed along upper surfaces of the central cylinder and of the second connector, respectively, the first and second upper coils generating a ponderomotive force toward exits of the first and second channels to accelerate the plasma toward the exits.

5. The multi-channel plasma accelerator of claim 3, wherein the plurality of side coils comprise first and second side coils formed along an inner side of the first outer cylinder and an outer side of the second outer cylinder, respectively, the first and second side coils operating to move waves of the electromagnetic field formed inside the first and second channels, and to accelerate the plasma inside the first and second channels.

6. The multi-channel plasma accelerator of claim 1, wherein at least one of heights and widths of the first and second channels and heights of exits of the first and second channels is changed to uniformly adjust a density of the plasma formed inside the first and second channels.

7. The multi-channel plasma accelerator of claim 1, wherein the central cylinder and the first and second outer cylinders are dielectrics.

8. A multi-channel plasma accelerator comprising:
a central cylinder formed along a surface comprising a blocked upper surface so as to form a first channel inside the cylinder; and
first through fourth outer cylinders formed along the surface, each having an identical coaxial shaft to the central cylinder, and each having a diameter d1, d2, d3, and d4, respectively, wherein d1 is greater than a diameter of the central cylinder, and d2>d1, d3>d2, and d4>d3, and
wherein a second channel is formed between the first and second outer cylinders, and a third channel is formed between the third and fourth outer cylinders.

9. The multi-channel plasma accelerator of claim 8, further comprising:
a first connector connecting the central cylinder to the first outer cylinder;
a second connector connecting the first outer cylinder to the second outer cylinder;
a third connector connecting the second outer cylinder to the third outer cylinder; and
a fourth connector connecting the third outer cylinder to the fourth outer cylinder.

10. The multi-channel plasma accelerator of claim 8, further comprising:
a plurality of upper coils independently supplied with radio frequency power to induce an electromagnetic field so as to form a plasma; and
a plurality of side coils offsetting a portion of the electromagnetic field in an axis direction so as to accelerate the plasma in the axis direction.

11. The multi-channel plasma accelerator of claim 10, wherein the plurality of upper coils comprises first, second, and third upper coils formed along upper surfaces of the central cylinder, the second connector, and the fourth connector, respectively, and generating a ponderomotive force toward exits of the first, second, and third channels so as to accelerate the plasma toward the exits.

12. The multi-channel plasma accelerator of claim 10, wherein the plurality of side coils comprise first, second, and third side coils formed along an inner side of the first outer cylinder, an inner side of the third outer cylinder, and an outer side of the fourth outer cylinder, respectively, the plurality of side coils operating to move waves of the electromagnetic field formed inside the first, second, and third channels, and to accelerate the plasma inside the first, second, and third channels.

13. The multi-channel plasma accelerator of claim 8, wherein at least one of height and widths of the first, second , and third channels and heights of exits of the first, second, and third channels is changed so as to uniformly adjust a density of the plasma formed inside the first, second, and third channels.

14. The multi-channel plasma accelerator of claim 8, wherein the central cylinder and the first, second, and third outer cylinders are dielectric.

15. An etching apparatus etching a wafer used for manufacturing a semiconductor chip using the multi-channel plasma accelerator of claim 1.

16. An etching apparatus etching a wafer used for manufacturing a semiconductor chip using the multi-channel plasma accelerator of claim 8.
